(19) United States
(12) Patent Application Publication
(10) Pub. No.: US 2025/0369918 A1
(43) Pub. Date: Dec. 4, 2025

(54) SENSOR WITH IMPROVED ELECTRICAL PROPERTIES

(71) Applicant: Endress+Hauser Conducta GmbH+Co. KG, Gerlingen (DE)

(72) Inventors: Stefan Paul, Döbeln (DE); Matthäus Speck, Göpfersdorf (DE); Stefan Pilz, Geithain (DE); Thomas Wilhelm, Chemnitz (DE)

(21) Appl. No.: 19/223,519

(22) Filed: May 30, 2025

(30) Foreign Application Priority Data
Jun. 4, 2024 (DE) 10 2024 115 520.5

(51) Int. Cl. G01N 27/416; H01H 36/00

(52) U.S. Cl. CPC G01N 27/416; H01H 36/0013

(57) ABSTRACT

A sensor includes a sensor unit including a sensor element, a reference electrode, evaluation electronics, an electrical connection to connect the evaluation electronics to the sensor element and to the reference electrode, and a first connection unit. The sensor unit is configured to detect a potential difference between the sensor element and the reference electrode. The sensor further includes a cable unit having a second connection unit and further having a permanent magnet on the medium-facing side of the cable unit. The sensor unit and the cable unit are designed to be electrically and mechanically connected to one another via an interface. The electrical connection comprises a reed switch that is designed to assume an electrically conductive state in the presence of the permanent magnet and an electrically non-conductive state when the magnetic field strength at the reed switch falls below a threshold value.

### CROSS-REFERENCE TO RELATED APPLICATION

The present application is related to and claims the priority benefit of German Patent Application No. 10 2024 115 520.5, filed on Jun. 4, 2024, the entire contents of which are incorporated herein by reference.

### TECHNICAL FIELD

The present disclosure relates to a potentiometric sensor with improved electrical properties.

### BACKGROUND

In the prior art, there are sensors in which the evaluation electronics or sensor circuit is located in the sensor element.

Sensors with this technology are connected via a galvanic, conductive, or inductive interface to a cable that is responsible for energy and data transport.

The disadvantage of the sensor arrangements according to the prior art is that the evaluation electronics electrically connected to the sensor element can cause current flows at the sensor element, in particular if the measuring circuit is closed through electrolyte contact of the sensor. The evaluation electronics are connected to the data processing unit via a galvanic or conductive interface, or via an inductive interface.

The evaluation electronics are electrically connected to the sensor element and the reference electrode, whereby the potentials at the sensor element and the reference electrode are equalized when the sensor is not in operation.

The presence of potential equalization at the sensor element leads to longer settling times during sensor operation and to a shift in the measuring potential.

### SUMMARY

The object of the present disclosure is therefore to provide a sensor which prevents the charge transport on the sensor element and on the sensor and thus reduces the settling time during operation. The object is achieved by the sensor according to the present disclosure.

The sensor according to the present disclosure comprises: a sensor unit comprising at least one sensor unit, a reference electrode, wherein the sensor element and the reference electrode are arranged on the side facing the medium during operation, evaluation electronics, an electrical connection designed to connect the evaluation electronics to the sensor element and to the reference electrode, a first connection unit, wherein the evaluation electronics and the first connection unit are arranged on the side, facing away from the medium during operation, of the sensor unit, wherein the sensor unit is configured to detect a potential difference between the sensor element and the reference electrode, and a cable unit having a second connection unit on the side, facing the sensor during operation, of the cable unit, characterized in that the cable unit further comprises a permanent magnet on the side, facing the medium during operation, on the outside of the housing of the cable unit or on the inside of the housing of the cable unit, which permanent magnet is designed to generate a magnetic field, wherein the sensor unit and the cable unit are designed to be mechanically and electrically connected to each other via an interface, wherein the electrical connection comprises a reed switch and is designed to be switched between an electrically conductive state and an electrically non-conductive state, wherein the reed switch is designed to assume the electrically conductive state in the presence of the magnetic field of the permanent magnet and to assume the electrically non-conductive state as soon as the magnetic field strength at the reed switch falls below a threshold value.

In one embodiment, the first connection unit is designed as a first inductance or as a first plug connection, and the second connection unit is designed as a second inductance or as a second plug connection.

In one embodiment, the electrical connection is an inductive connection mediated by a changing magnetic field between the first inductance and the second inductance when the first and second connection units are mechanically connected to each other.

The threshold value is exceeded when the connection between the sensor unit and the cable unit is separated.

The installation of a reed switch between the sensor element or the reference electrode and the evaluation electronics provides an electrical connection which can be separated and thus prevents potentials from building up on the sensor element. Such an arrangement also provides protection against piracy and enables improved measurement performance.

The field strength for closing the reed switch is defined by the pull-in sensitivity (AWan, PI). The pull-in sensitivity (Awan, PI) specifies the magnetic field strength for closing the switch. For permanent magnets, the switch-on point is measured as the switch-on distance in mm. The pull-in sensitivity is also specified via the magnetic flux density or as the product of the number of turns and the current of the actuating coil (Awan).

The switch-off sensitivity (Awab, DO) describes the switch-off point of the reed switch and is determined analogously to Awan, in that the magnetic field is reduced until the contact drops.

With a known coil, the number of ampere turns (AW or AT of ampere turns) until the pull-in can be determined. To do this, the current in a coil wound around the contact is increased to the switch-on point and multiplied by the number of turns.

Typical pull-in sensitivities for commercially available reed switches are in the range of 10 to 60 AT. In a preferred embodiment, the attraction sensitivity of the reed switch is 10 to 60 AT.

The determination of the pull-in sensitivity (Awan, PI) and the shut-off sensitivity (Awab, DO) is described, for example, in JP2830304B2. The pull-in sensitivity requires a higher magnetic field strength than the pull-out sensitivity. The relationship between the pull-in (Awan) and shut-off magnetic field strength (Awab) is called switching hysteresis.

In one embodiment, the second inductance is designed as a cylinder coil and arranged in the housing of the cable unit.

In one embodiment, the reed plates of the reed switch comprise a ferromagnetic material, wherein the ferromagnetic material is preferably selected from iron, nickel, cobalt, or an alloy thereof.

In one embodiment, the reed switch has a shielding against magnetic fields from the environment.

The shielding is effected by a housing of the reed switch, which shields electromagnetic fields. Preferred are materials with a high magnetic permeability, e.g., mu-metal, plastic, or ceramic comprising metal or metal alloy with a high magnetic permeability. The electromagnetic shielding is designed around the reed switch or the armature such that the shielding has an opening or a recess which is opposite the permanent magnet and is located at a small enough distance from the permanent magnet for the reed switch to be switched on by the magnetic field of the permanent magnet when the sensor unit is connected to the cable unit.

In one embodiment, a mu-metal comprises 77% nickel, 16% iron, 5% copper, and 2% chromium or molybdenum.

In another embodiment, a mu-metal comprises 80% nickel, 5% molybdenum, small amounts of other substances such as silicon, and 12-15% iron.

The position and size of the recess in the shielding component are appropriately dimensioned such that the contact area is exposed to the magnetic field of the permanent magnet. The magnetic field acts upon the reed switch and triggers a switching process.

In one embodiment, the sensor element is designed as an electrochemical sensor element.

In one embodiment, the sensor is designed to transmit energy unidirectionally from the cable unit to the sensor unit, as well as data bidirectionally, in particular the electrical measurement variable and/or the process variable.

In a preferred embodiment of the sensor, the mechanical connection between the sensor unit and the cable unit is releasable.

In one embodiment of the sensor, the mechanical connection is designed as a plug connection, a screw connection, or as a bayonet lock.

In one embodiment, the sensor is designed as a high-impedance pH sensor.

The present disclosure also relates to a method for commissioning the sensor according to the present disclosure or an embodiment thereof, wherein the sensor unit and the cable unit are mechanically connected to each other, wherein, through the mechanical connection, the sensor unit is connected to the cable unit via the interface by means of the first and second connection units, wherein, via the interface, the sensor unit is supplied with energy from the cable unit, and data, in particular concerning the electrical measured variable and/or the process variable, is transmitted bidirectionally between the sensor unit and the cable unit, and the reed switch is brought into the electrically conductive state.

The present disclosure further relates to the use of the sensor according to the present disclosure or an embodiment thereof for determining the concentration of an analyte in solution, wherein the sensor unit and the cable unit are connected to one another, and the sensor unit is brought into contact with a solution to be analyzed, preferably an aqueous solution containing an analyte.

In one embodiment of the use, the analyte is selected from hydronium or hydrogen ions, a concentration of nitrate ions, chloride ions, ammonium ions, alkali ions, e.g., sodium ions, lithium ions or potassium ions, and alkaline earth ions—for example, calcium ions or magnesium ions.

The sensor element according to the present disclosure is explained below using exemplary embodiments in conjunction with the drawings 1 to 2.

### BRIEF DESCRIPTION OF THE DRAWINGS

Shown are:

FIG. 1 shows the sensor according to the present disclosure in the unconnected state.

FIG. 2 shows the sensor according to the present disclosure in the connected state.

### BRIEF DESCRIPTION OF THE DRAWINGS

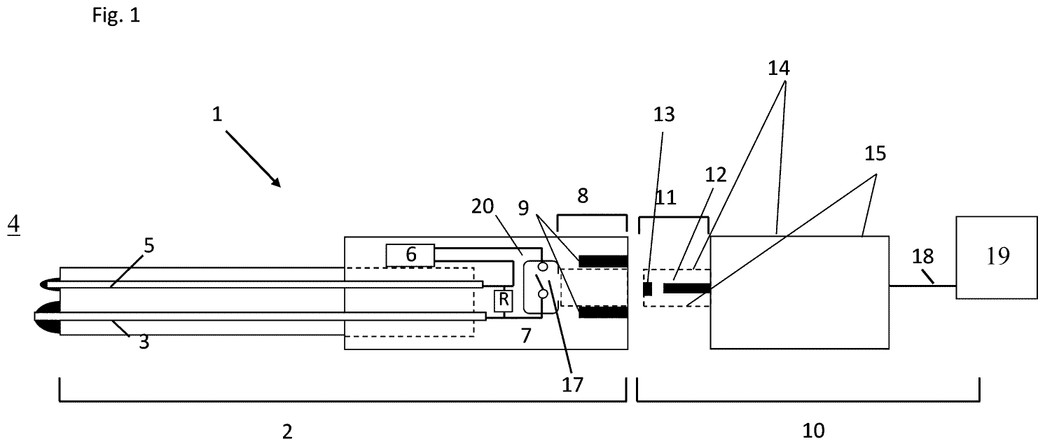

FIG. 1 shows the sensor according to the present disclosure in the unconnected state. The sensor 1 according to the present disclosure is constructed from two components, wherein the first component is a sensor unit 2 and the second unit is a cable unit 10. The sensor unit 2 comprises a sensor element 3 and a reference electrode 5, wherein the sensor element 3 and the reference electrode 5 are arranged on the side 4 facing the medium during operation. The sensor unit also has evaluation electronics 6 and an electrical connection 7, which is designed to connect the evaluation electronics to the sensor element 3. The sensor unit 2 further comprises a first connection unit 8 comprising a first inductance 9, wherein the evaluation electronics 6 and the first connection unit 8 are arranged on the side, facing away from the medium during operation, of the sensor unit 2. The sensor unit 2 is configured to detect a potential difference between the sensor element 3 and the reference electrode 5. The electrical connection 7 of the sensor unit 2 comprises a reed switch 17, which is designed to be switched between an electrically conductive state and an electrically non-conductive state. The cable unit 10 has a second connection unit 11 comprising a second inductance 12 on the side, facing the sensor during operation, of the cable unit 10. In another embodiment, the first and second connection units (8, 11) comprise a first and a second conductive or galvanic plug connection. The cable unit is connected to a data processing unit 19 via a cable 18. This connection is designed to be mechanically and electrically releasable via an interface 16.

The reed switch 17 comprises contact tongues made of a ferromagnetic material, e.g., an iron-nickel alloy, fused into a glass tube. In an electrically unconnected state of the sensor, in which the sensor unit 2 and the cable unit 10 are not electrically connected, the reed switch 17 is open and does not conduct current. Thus, potentials at the sensor element and the reference electrode cannot equalize in a switched-off state.

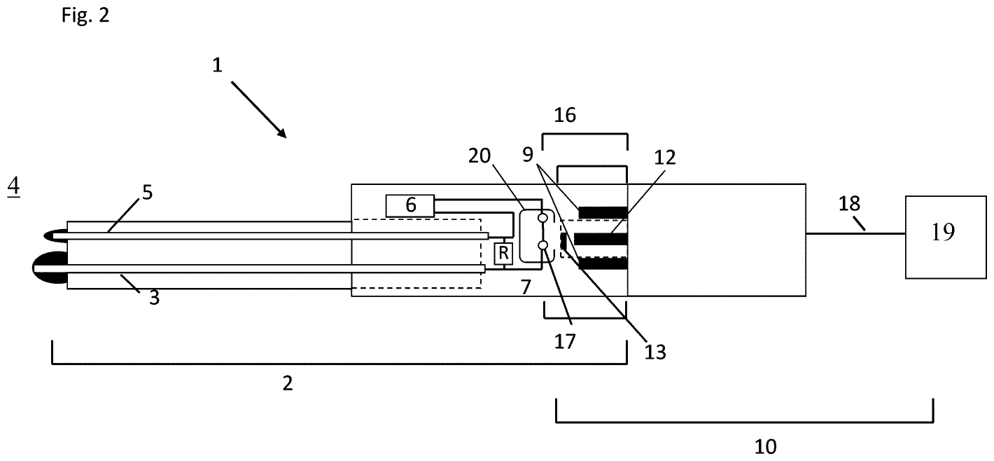

FIG. 2 shows the sensor 1 according to the present disclosure in the mechanically and inductively connected state. In the electrically and inductively connected state, the first connection unit 8 and the second connection unit 11 form an interface 16. The interface 16 is a releasable interface 16 which connects the sensor unit 2 and the cable unit 10 both mechanically, e.g., via a plug-in unit, a bayonet lock, or as a screw lock, and electrically via a galvanic or conductive interface or via induction, and thus electrically without contact. The interface 16 enables wireless transmission of energy from the cable unit 10 to the sensor unit 2 as well as bidirectional signal transmission between the sensor unit 2 and the cable unit 10.

In the connected state, the reed switch 17 is also closed by the magnetic field of the permanent magnet 13; the magnetic field of the permanent magnet 13 magnetizes the ferromagnetic contact points of the reed switch 17. As a result, an electrical connection is established between the sensor element 2 and the evaluation electronics 6, and the alternating current can flow through the switch.

To reopen the reed switch 17, the sensor 1 is switched to the unconnected state.

All the embodiments of the sensor 1 described above can be combined with each other, provided that this is technically possible.

Reference signs are not to be understood as a limitation of the scope of the subject matter protected by the claims. They serve only the purpose of making the claims easier to understand.

### LIST OF REFERENCE SIGNS

(1) Sensor
(2) Sensor unit
(3) Sensor element
(4) Side facing the medium during operation
(5) Reference electrode
(6) Evaluation electronics
(7) Electrical connection
(8) First connection unit
(9) First inductance or first plug connection
(10) Cable unit
(11) Second connection unit
(12) Second inductance or second plug connection
(13) Permanent magnet
(14) Outside of the cable unit housing
(15) Inside of the cable unit housing
(16) Interface
(17) Reed switch
(18) Cable
(19) Data processing unit
(20) Shielding, reed switch housing
(R) Voltage meter

What is claimed is:

1. A sensor, comprising:
a sensor unit including:
a sensor element;
a reference electrode, wherein the sensor element and the reference electrode are arranged on a side of the sensor unit facing a medium during operation;
evaluation electronics;
an electrical connection that is designed to connect the evaluation electronics to the sensor element and to the reference electrode; and
a first connection unit, wherein the evaluation electronics and the first connection unit are arranged on a side of the sensor unit facing away from the medium during operation of the sensor unit,
wherein the sensor unit is configured to detect a potential difference between the sensor element and the reference electrode; and
a cable unit, including:
a second connection unit on a side of the cable unit facing the sensor unit during operation; and
a permanent magnet on a side, facing the medium during operation, on an outside of a housing of the cable unit or on an inside of the housing of the cable unit, wherein the permanent magnet is designed to generate a magnetic field,
wherein the sensor unit and the cable unit are designed to be mechanically and electrically connected to one another via an interface,
wherein the electrical connection of the sensor unit includes a reed switch and is designed to be switched between an electrically conductive state and an electrically non-conductive state, and
wherein the reed switch is designed to assume the electrically conductive state in the presence of the magnetic field of the permanent magnet and to assume the electrically non-conductive state as soon as a magnetic field strength at the reed switch falls below a threshold value.

2. The sensor according to claim 1, wherein the first connection unit is designed as a first inductance or as a first plug connection, and the second connection unit is designed as a second inductance or as a second plug connection.

3. The sensor according to claim 2, wherein the electrical connection is an inductive connection mediated via a changing magnetic field between the first inductance and the second inductance when the first and the second connection units are mechanically connected to one another.

4. The sensor according to claim 2, wherein the second inductance is designed as a cylindrical coil and is arranged in the housing of the cable unit.

5. The sensor according to claim 1, wherein the reed switch includes reed plates which comprise a ferromagnetic material selected from iron, nickel, cobalt, or an alloy thereof.

6. The sensor according to claim 5, wherein the reed switch has a shielding against magnetic fields from an environment.

7. The sensor according to claim 1, wherein the sensor element is designed as an electrochemical sensor element.

8. The sensor according to claim 1, wherein the sensor is designed to transmit energy unidirectionally from the cable unit to the sensor unit and data bidirectionally.

9. The sensor according to claim 1, wherein the mechanical connection between the sensor unit and the cable unit is releasable.

10. The sensor according to claim 9, wherein the mechanical connection is designed as a plug connection, a screw connection, or as a bayonet lock.

11. The sensor according to claim 1, wherein the sensor is a high-impedance pH sensor.

12. A method for commissioning a sensor, comprising:
providing the sensor, including:
a sensor unit including:
a sensor element;
a reference electrode, wherein the sensor element and the reference electrode are arranged on a side of the sensor unit facing a medium during operation;
evaluation electronics;
an electrical connection that is designed to connect the evaluation electronics to the sensor element and to the reference electrode; and
a first connection unit, wherein the evaluation electronics and the first connection unit are arranged on a side of the sensor unit facing away from the medium during operation of the sensor unit,
wherein the sensor unit is configured to detect a potential difference between the sensor element and the reference electrode; and
a cable unit, including:
a second connection unit on a side of the cable unit facing the sensor unit during operation; and
a permanent magnet on a side, facing the medium during operation, on an outside of a housing of the cable unit or on an inside of the housing of the cable unit, wherein the permanent magnet is designed to generate a magnetic field,
wherein the sensor unit and the cable unit are designed to be mechanically and electrically connected to one another via an interface,
wherein the electrical connection of the sensor unit includes a reed switch and is designed to be switched between an electrically conductive state and an electrically non-conductive state, and
wherein the reed switch is designed to assume the electrically conductive state in the presence of the magnetic field of the permanent magnet and to assume the electrically non-conductive state as soon as a magnetic field strength at the reed switch falls below a threshold value;
mechanically connecting the sensor unit and the cable unit to each other, wherein, through the mechanical connection, the sensor unit is connected to the cable unit via the interface via the first connection unit and the second connection unit;
supplying energy from the cable unit to the sensor unit via the interface;
transmitting data bidirectionally between the sensor unit and the cable unit, and
bringing the reed switch into the electrically conductive state.
